(19) United States
(12) Patent Application Publication
(10) Pub. No.: US 2014/0223345 A1
(43) Pub. Date: Aug. 7, 2014

(54) METHOD FOR INITIATING COMMUNICATION IN A COMPUTING DEVICE HAVING A TOUCH SENSITIVE DISPLAY AND THE COMPUTING DEVICE

(71) Applicant: Samsung Electronics Co., Ltd., Suwon-si (KR)

(72) Inventors: Ravitheja TETALI, Bangalore (IN); Anand Prakash YADAV, Bangalore (IN); Joy BOSE, Bangalore (IN); Samarth Vinod DEO, Bangalore (IN); Tasleem ARIF, Bangalore (IN)

(73) Assignee: Samsung Electronics Co., Ltd., Suwon-si (KR)

(21) Appl. No.: 14/171,309

(22) Filed: Feb. 3, 2014

(30) Foreign Application Priority Data
Feb. 4, 2013 (IN) 492/CHE/2013

(51) Int. Cl. G06F 3/0486; G06F 3/0488; G06F 3/0482

(52) U.S. Cl. CPC G06F 3/0486; G06F 3/0482; G06F 3/0488
USPC 715/769; 715/845

(57) ABSTRACT

Provided are a method of initiating communication in a computing device including a touch sensitive display and the computing device. The method includes detecting a touch gesture that is performed on at least one tagged object included in an image displayed on the touch sensitive display and initiating, in response to the detection of the touch gesture, communication to at least one individual corresponding to the at least one tagged object selected or surrounded by the detected touch gesture, according to the detected touch gesture.

### RELATED APPLICATIONS

This application claims the benefit of Indian Patent Application No. 492/CHE/2013, filed on Feb. 4, 2013, in the Indian Patent Office and Korean Patent Application No. 10-2014-0012794, filed on Feb. 4, 2014, in the Korean Intellectual Property Office, the disclosures of which are incorporated herein in their entirety by reference.

### BACKGROUND

1. Field

One or more embodiments of the present invention relate to a method of initiating communication in a computing device including a touch sensitive display and the computing device.

2. Description of the Related Art

To improve searchability, web technologies allow a user to describe an object by using image tagging. Image tagging includes attaching text meta information or semantic linkages to an image or a portion of an image. By adding a name tag to an image, it is possible to improve information represented by the image and provide an additional meaning to the image. When an image is tagged, a plurality of functionalities may be derived from the tagged image. Images may be tagged in various ways, e. g., including group tagging whereby a tag associated with a person within an image automatically tags the same person in a plurality of images.

In most conventional methods, functionalities provided by image tagging are limited to arranging images in an album and sharing the images. Some of the conventional methods provide functions that are limited to search, editing, and processing of information by using image tagging.

In view of the foregoing, there is a need for a method and system for improving user experience by providing a plurality of functionalities in an intuitive manner using a gesture connected to a tagged image.

### SUMMARY

One or more embodiments of the present invention include a method of initiating communication in a computing device including a touch sensitive display and the computing device.

Additional aspects will be set forth in part in the description which follows and, in part, will be apparent from the description, or may be learned by practice of the presented embodiments.

According to one or more embodiments of the present invention, a method of initiating communication in a computing device including a touch sensitive display includes: detecting a touch gesture that is performed on at least one tagged object included in an image displayed on the touch sensitive display; and initiating, in response to the detection of the touch gesture, communication to at least one individual corresponding to the at least one tagged object selected or surrounded by the detected touch gesture, according to the detected touch gesture.

The initiating of the communication according to the detected touch gesture may include initiating communication for individuals corresponding to all tagged objects selected or surrounded by the touch gesture.

The communication may include at least one of making a call, sending a text message, and sending an email to the at least one individual corresponding to the at least one tagged object selected or surrounded by the touch gesture.

The touch gesture may include at least one of: a swipe right gesture on the at least one tagged object included in the image; a swipe left gesture on the at least one tagged object included in the image; a drag gesture in clockwise direction on the at least one tagged object included in the image; a drag gesture in counter-clockwise direction on the at least one tagged object included in the image; a loop gesture performed by encircling at least one tagged object selected from among a plurality of tagged objects in the image; a swipe up gesture on the at least one tagged object included in the image; a swipe down gesture on the at least one tagged object included in the image; a long tap gesture on the at least one tagged object included in the image; and a loop gesture performed by surrounding a folder containing a plurality of tagged images.

The initiating of the communication based on the detected touch gesture may include identifying the at least one individual corresponding to the at least one tagged object that is stored in a contact list on the computing device and initiating the communication to the individual.

According to one or more embodiments of the present invention, a computing device includes: a touch sensitive display; a memory for storing at least one instruction; and a processor for executing the at least one instruction, wherein the processor detects a touch gesture that is performed on at least one tagged object included in an image displayed on the touch sensitive display, in response to the execution of the at least one instruction, and initiates communication to at least one individual corresponding to the at least one tagged object selected or surrounded by the detected touch gesture according to the detected touch gesture, in response to the detection of the touch gesture.

These and/or other aspects will become apparent and more readily appreciated from the following description of the embodiments, taken in conjunction with the accompanying drawings. However, it should be understood that while the following descriptions indicate preferred embodiments and various specific details thereof, these descriptions are given by way of illustration, not for limitation. Various changes and modifications may be made within the scope of the present invention without departing from the spirit thereof, and the embodiments thereof include such changes and modifications.

### BRIEF DESCRIPTION OF THE DRAWINGS

These and/or other aspects will become apparent and more readily appreciated from the following description of the embodiments, taken in conjunction with the accompanying drawings wherein like reference numerals refer to like elements throughout, in which:

FIG. 1 is a block diagram of a computing device according to an exemplary embodiment of the present invention;

FIG. 2 is a block diagram of a module for processing a touch gesture on an image, according to an exemplary embodiment of the present invention;

FIG. 3 is a flowchart of a method of initiating communication in a computing device including a touch sensitive display, according to an exemplary embodiment of the present invention;

FIG. 4A illustrates a swipe right gesture on an image, which initiates an automatic group call for individuals corresponding to all tagged objects in the image, according to an exemplary embodiment of the present invention;

FIG. 4B illustrates a swipe left gesture performed on an image to trigger automatic text messaging for individuals corresponding to all tagged objects in the image, according to an exemplary embodiment of the present invention;

FIG. 5A illustrates a clockwise loop gesture that is performed by encircling tagged objects in an image selected by a user so as to initiate an automatic conference call for a group of individuals corresponding to the tagged objects within a circular loop, according to an exemplary embodiment of the present invention;

FIG. 5B illustrates a counter-clockwise loop gesture that is performed by connecting together tagged objects in an image selected by a user so as to initiate an automatic conference call for a group of individuals corresponding to objects following the loop gesture;

FIG. 6 illustrates a clockwise round loop gesture on an image folder according to an exemplary embodiment of the present invention;

FIG. 7 illustrates a swipe up gesture performed on a tagged object to trigger an automatic call for an individual corresponding to the tagged object, according to an exemplary embodiment of the present invention; and

FIGS. 8A and 8B illustrate a pinch gesture or spread gesture that is performed on an individual corresponding to a tagged object by using two fingers.

### DETAILED DESCRIPTION

Exemplary embodiments and various features and advantages thereof will be described more fully with respect to a non-restrictive exemplary embodiment which is illustrated in the accompanying drawings and the following detailed description. In the description of the present invention, well-known methods and components will not be described so as not to unnecessarily obscure the essence of the present invention. Exemplary embodiments used in the specification are not intended to limit the present disclosure but to aid in the understanding of implementation of the embodiments, and will be described so that they may be easily implemented by one of ordinary skill in the art. As used herein, the term “and/or” includes any and all combinations of one or more of the associated listed items. Expressions such as “at least one of,” when preceding a list of elements, modify the entire list of elements and do not modify the individual elements of the list.

According to an exemplary embodiment of the present invention, a method of providing a plurality of functionalities such as calling, text messaging, emailing to a user of a touch screen device by using a plurality of touch-based gestures on a tagged digital image (tagged image) displayed on a computing device and the computing device. The tagged image is an image having at least one tagged object among at least one object in an image. The tagged object may be an object, but in the present embodiment, it means an individual who a user desires to communicate with. A computing device may map an individual (person) corresponding to each tagged object in an image to a corresponding unique contact in a contact list on the computing device. According to the present embodiment, a face recognition technique is used to automatically tag all images showing a person in a corresponding contact from a contact list when any one of the images is tagged.

In one embodiment, any object in an image may be tagged in a unique contact within a contact list on a computing device.

According to the present embodiment, an option (functionality) is provided to a user. The option may include, but are not limited to, calling, text messaging, and emailing to an individual corresponding to a tagged object in a tagged image, individuals corresponding to all tagged objects therein, or individuals corresponding to only selected tagged objects therein. All functionalities are defined by a unique preconfigured touch gesture stored in a gesture database.

In one embodiment, various touch gestures may include, but are not limited to, a swipe right gesture, a swipe left gesture, a long tap gesture, a clockwise round loop gesture, and a counter-clockwise round loop gesture.

In one embodiment, the user may configure and customize a touch gesture by using one or a plurality of fingers.

In one embodiment, while viewing images of persons corresponding to at least one tagged image on a social networking website during browsing on a computing device, a user may make a call and send a text message or an e-mail to the persons corresponding to the tagged objects and who are in a contact list stored in the computing device.

In one embodiment, a touch screen device may include, but are not limited to, a mobile phone, a personal digital assistant (PDA), a tablet PC, a notepad, a laptop, and a camera.

According to the present embodiment, user experience may be enhanced by providing functions such as group calling, group texting, or group emailing in an intuitive manner.

Throughout the detailed description, the terms a “person,” “persons,” and an “individual” are used interchangeably without distinguishing one from the other.

In the detailed description, the terms a “gesture” and a “touch gesture” are also used interchangeably.

Reference will now be made in detail to embodiments, examples of which are illustrated in the accompanying drawings, wherein like reference numerals refer to like elements throughout.

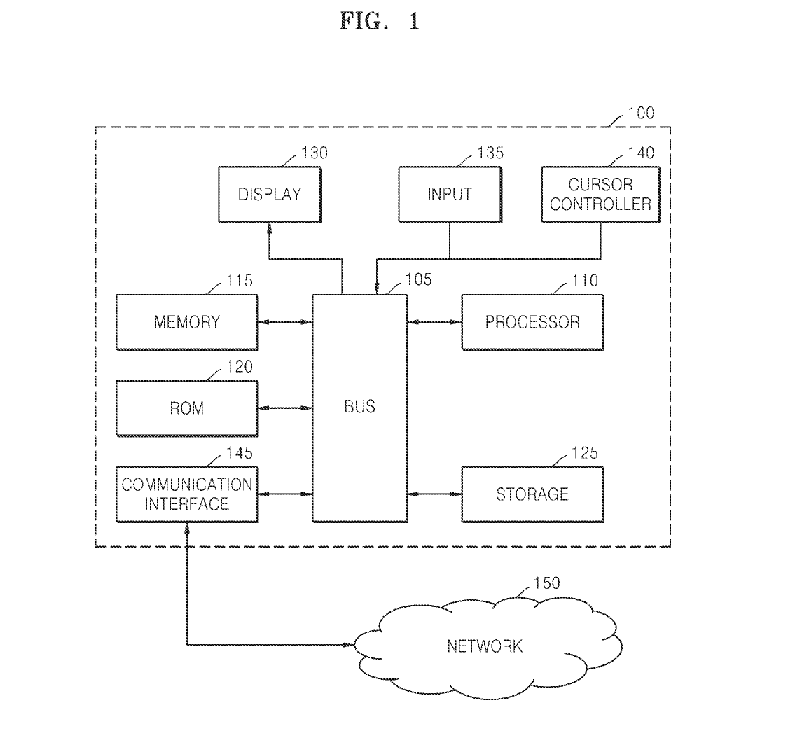

FIG. 1 is a block diagram of a computing device 100 according to an exemplary embodiment of the present invention.

Referring to FIG. 1, the computing device 100 includes a bus 105, a processor 110, a memory 115, a read-only memory (ROM) 120, a storage 125, a display 130, an input 135, a cursor controller 140, and a communication interface 145.

The bus 105 is a medium for data communication between components within the computing device 100.

The processor 110 is connected to the bus 105 to process information and performs a process described in this specification by executing instructions contained in a memory 115. In particular, the processor 110 detects a touch gesture performed on at least one tagged object in an image that is displayed on a touch sensitive display, and in response to detection of the touch gesture, initiates communication to at least one individual corresponding to the at least one tagged object selected or encircled by the detected touch gesture according to the detected touch gesture. The processor 110 may be mounted on a single chip or a plurality of chips.

The memory 115 (e. g., a read access memory (RAM) or another dynamic storage device) connected to the bus 105 stores information and instructions to be executed by the processor 110. The memory 115 may be used to store temporary variables or other intermediate information while the processor 110 is executing an instruction. In particular, the memory 115 provides a storage for storing data for touch gestures that are performed on an image according to an embodiment of the present invention and a storage for storing contact details of individuals corresponding to tagged objects that user desires to maintain. In one embodiment, the stored gestures may be preconfigured by a device and/or user. Configured gestures may be made by one finger or a plurality of fingers.

The ROM 120 connected to the bus 105 may also store static information and instructions that are used for the processor 110. The ROM 120 may also function as a storage that stores data related to touch gestures.

The storage 125 may be a magnetic disc or optical disc, and is connected to the bus 105 to store information.

The display 130 displays processed data and is coupled to the computing system 100 via the bus 105. For example, the display 130 may include a touch sensor display for detecting a user's touch gesture that is performed on an individual corresponding to a tagged object in an image according to an embodiment of the present invention.

An input 135 has English alphabetic, numeric and other keys and is coupled to the bus 105 to deliver information and command selections to the processor 110.

The cursor controller 140 is another type of a user input device for delivering directional information and command selections to the processor 110 and for controlling movements of a cursor on the display 130. For example, the cursor controller 140 may be a mouse, a trackball, or cursor direction keys.

Various embodiments of the present invention are related to use of the computing device 100 for implementing techniques presented herein. In some embodiments, the computing device 100 performs the present techniques in response to the processor 110 for executing instructions stored in the memory 115. The instructions may be read into the memory 115 from another machine-readable medium (e.g., the storage 125). The processor 110 may perform the process described herein by executing the instructions.

In some embodiments, the processor 110 may include at least one processing unit for performing at least one function of the processor 110. The at least one processing unit may be a hardware circuit that is substituted by software instructions for performing particular functions or used in combination with the software instructions. The processing unit may also be called a module.

The term “machine-readable medium” as used herein refers to any medium that participates in providing data for a machine to perform specified functions. In one embodiment implemented using the computing device 100, various types of machine-readable media may participate in providing instructions to the processor 110 for execution. The machine-readable media may be volatile or non-volatile storage media. Volatile storage media include a dynamic memory such as the memory 115. Non-volatile storage media include an optical or magnetic disc such as the storage 125. All machine-readable media must be tangible so that a physical mechanism for reading instructions into a machine may detect instructions contained in the media.

For example, common types of the machine-readable media include a floppy disk, a flexible disk, a hard disk, a magnetic tape or any other magnetic medium, a CD-ROM or any other optical medium, punchcards, a papertape, any other physical medium having patterns of holes, a RAM, a Programmable ROM, and Erasable PROM (EPROM), a FLASH-EPROM, and any other memory chip or cartridge.

In another embodiment, the machine-readable media may be transmission media including coaxial cables, copper wires, and optical fibers, or including wires having the bus 105. The transmission media may take the form of acoustic or light waves such as waves generated during radio-wave and infrared data communication. Examples of the machine-readable media may also include any medium that a mobile electronic device can read, but are not limited thereto. For example, instructions may initially be stored on a magnetic disk of a remote computer. The remote computer may load the instructions into its dynamic memory and send the instructions over a telephone line by using a modem. A modem local to the computing device 100 may receive data on the telephone line and use an infrared transmitter to convert the data into an infrared signal. An infrared detector may receive the data carried in the infrared signal, and appropriate circuitry may provide the data to the bus 105. The bus 105 sends the data to the memory 115, and the processor 110 retrieves the instructions from the memory 115 for execution. The instructions received by the memory 115 may selectively be stored on the storage 125, either before or after execution by the processor 110. The transmission media must be tangible so that a physical mechanism for reading instructions into a machine may detect instructions contained in the media.

The computing device 100 further includes the communication interface 145 connected to the bus 105. The communication interface 145 provides bidirectional data communication for connecting the computing device 100 with a web server on a network via the network 150. For example, the communication interface 145 may be an integrated services digital network (ISDN) card or modem to provide a data message connection to a corresponding type of telephone line. As another example, the communication interface 145 may be a local area network (LAN) card for providing a data communication connection to a compatible LAN. In all these implementations, the communication interface 145 sends and receives electrical signals, electromagnetic signals, or optical signals that carry digital data streams representing various types of information.

The computing device 100 may consist of multiple homogeneous and/or heterogeneous cores, different kinds of multiple CPUs, special media and other accelerators.

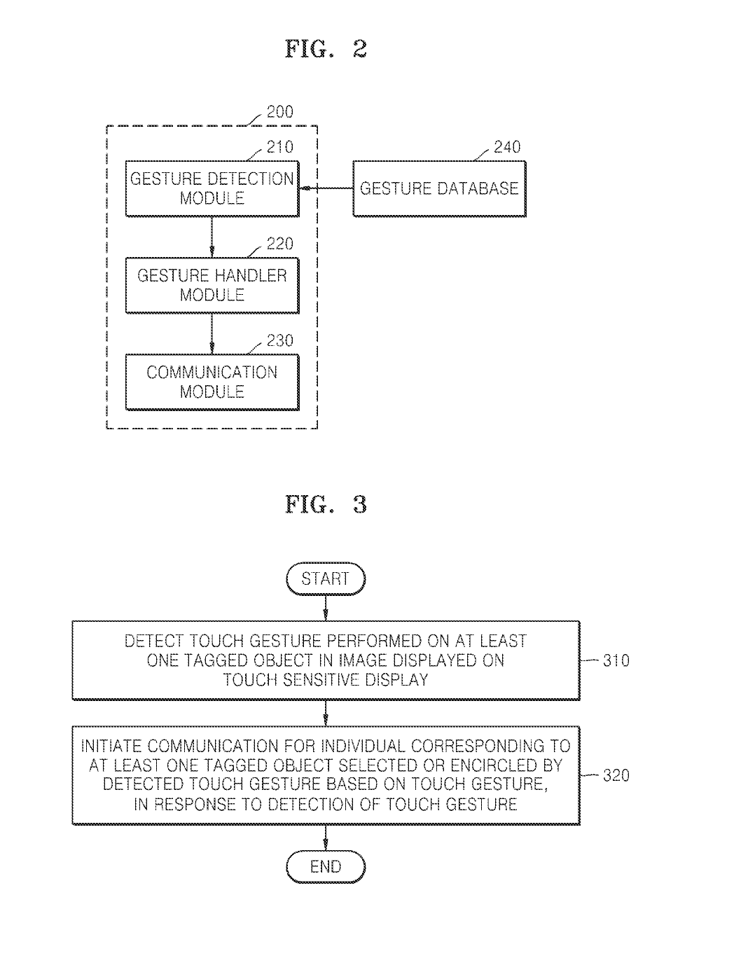

FIG. 2 is a block diagram of a module 200 for processing a touch gesture on an image (hereinafter, referred to as a touch gesture processing module), according to an exemplary embodiment of the present invention.

The touch gesture processing module 200 may be realized in hardware, software, or a combination of both hardware and software. If the touch gesture processing module 200 is realized in software, the touch gesture processing module 200 may be stored in the memory (115 in FIG. 1), and its function may be implemented as the processor (110 in FIG. 1) executes instructions contained therein.

Referring to FIG. 2, the touch gesture processing module 200 includes a gesture detection module 210, a gesture handler module 220, and a communication module 230.

A gesture database 230 may be included in the memory 115, the ROM (120 in FIG. 1), or the storage (125 in FIG. 1), and stores a plurality of gestures that may be performed on a tagged object in an image and functionalities respectively corresponding to the plurality of gestures. The functionalities refer to operations or functions performed correspondingly to the plurality of gestures and may include, for example, calling, emailing, text messaging, group emailing, and group texting.

The gesture detection module 210 provides an interface for receiving touch gestures performed by a user on an image displayed on a touch sensitive display and compares input gestures that is, the received touch gestures with preconfigured gestures stored in the gesture database 230 to classify the input gestures into swipe right and swipe left. The gesture detection module 210 also maps the detected gestures together with predefined functionalities (including, but not limited to, calling, text messaging, and emailing) to an individual or a group of individuals corresponding to a tagged object in an image.

The gesture handler module 220 processes the detected gestures and thereafter accesses contact details of persons corresponding to a tagged object in a contact list that is stored in the computing device 100. The gesture handler module 220 also determines communication that the user desires to set up according to the result of analysis of the performed input gestures. Then, the gesture handler module 220 accesses telephone number(s) or email ID(s) necessary for initiating the communication.

The communication module 230 provides a mechanism for initiating (triggering) communication for an individual corresponding to a tagged object and who is identified according to an input gesture made by the user.

Based on a functionality specified by the detected gesture, a group call, a short message service (SMS), or an email message is initiated for a person corresponding to at least one tagged object and who is identified according to the result of analysis of the input gesture.

The present embodiment may be implemented using at least one software program that is executed on at least one hardware device and performs a network management function in order to control components. The components illustrated in FIGS. 1 and 2 include blocks, and the blocks may be a hardware device, a combination of a hardware device and a software module, or all of them.

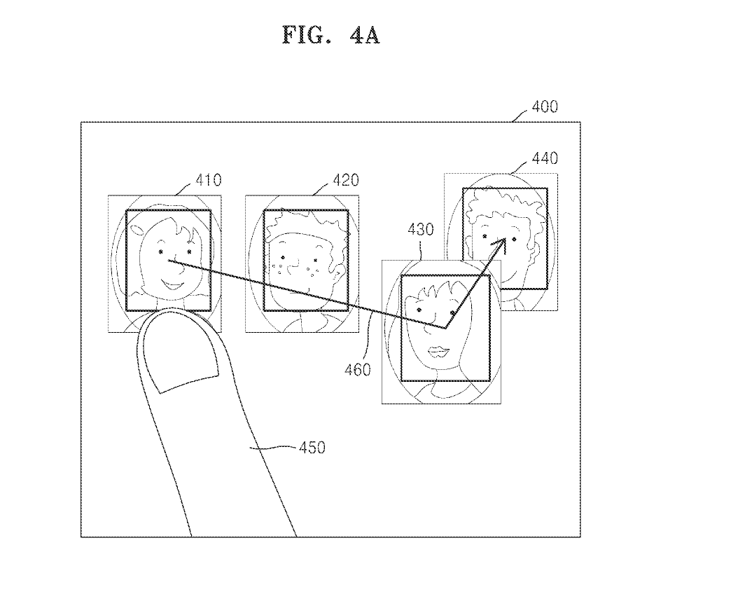

FIG. 3 is a flowchart of a method of initiating communication in a computing device including a touch sensitive display, according to an exemplary embodiment of the present invention.

Referring to FIG. 3, a computing device detects a touch gesture that is performed on a tagged image displayed on a touch sensitive display (Operation 310).

In detail, the gesture detection module (210 in FIG. 2) of the computing device receives a touch gesture made by a user on at least one tagged object in a displayed image and compares the received touch gesture with a preconfigured touch gesture stored in the gesture database (230 in FIG. 2) so as to identify the received touch gesture. The gesture detection module 210 also determines predefined functionalities (including, but not limited to, calling, text messaging, and emailing) corresponding to the identified touch gesture. In other words, the detected touch gesture is used to determine a person (all persons or some selected persons) who a user desires to communicate with, among individuals corresponding to all tagged objects in an image. The detected touch gesture is also used to determine the type of communication (calling, text messaging, and emailing) to be initiated for an identified individual corresponding to at least one tagged object.

In response to detection of the touch gesture, the computing device initiates communication to at least one the individual corresponding to the at least one tagged object in the image, selected or surrounded or encircled by the detected touch gesture (Operation 320).

In detail, the gesture handler module (220 in FIG. 2) receives information determined by the gesture detection module 210, i.e., information about a person who the user desires to communicate with and the type of communication and accesses contact details (e.g., a telephone number and an email ID) of the identified individual through a contact list stored in the computing device. Then, the communication module 230 automatically initiates desired communication (induced from the user's input gesture) with the identified individual corresponding to the at least one tagged object.

Examples of communication functionalities provided by embodiments of the present invention will now be described.

According to an embodiment of the present invention, an input gesture may be configured to provide a plurality of options to a user before the user initiates communication. For example, if the input gesture is identified as a gesture made by the user to initiate email communication with individuals corresponding to all tagged objects in an image, additional options such as date and time when the user desires to initiate the email communication with each of the individuals may be provided to the user.

In another embodiment, an option for configuring a user-defined gesture by using one finger or a plurality of fingers may be provided to the user.

In one embodiment, by recognizing a touch gesture performed on an image of at least one tagged object that a user views on a social networking site while browsing on the computing device 100, the user may initiate communication with individuals corresponding to the at least one tagged object and who are in a contact list stored in the computing device 100.

Various operations illustrated FIG. 3 may be performed in the specified order, in a different order, or simultaneously. In some embodiments, some of the operations may be omitted.

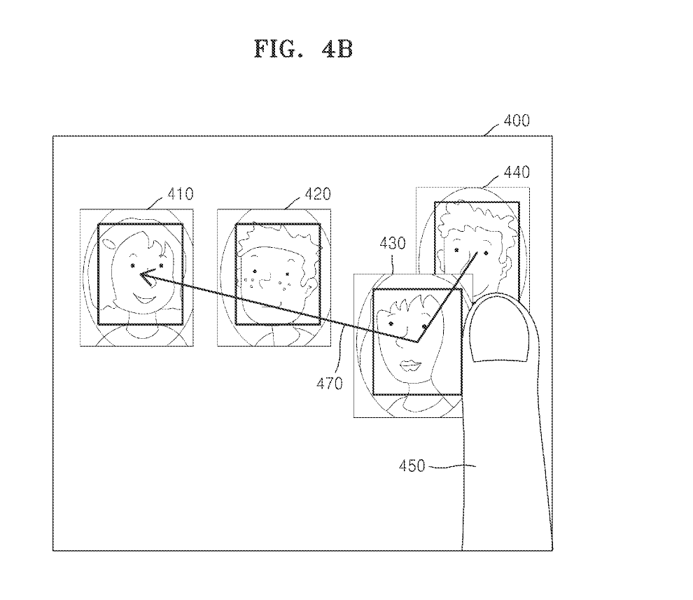

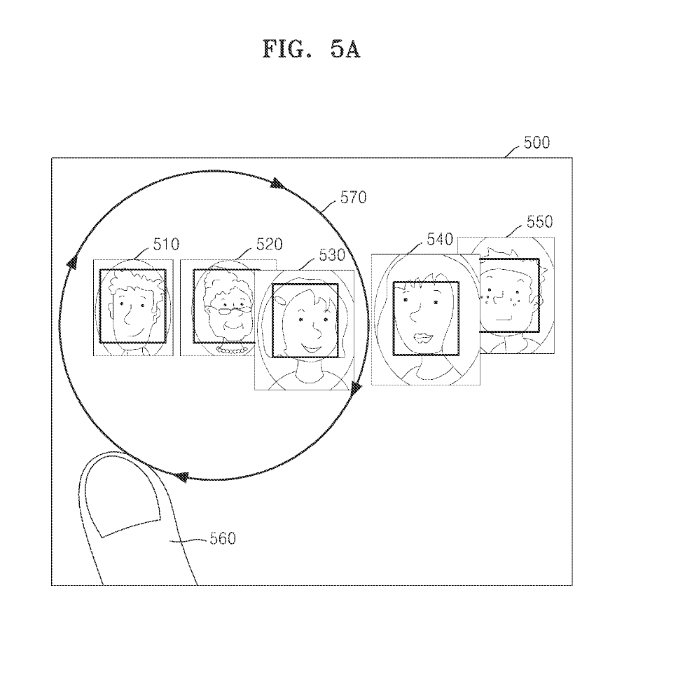

FIG. 4A illustrates a swipe right gesture 460 performed on an image 400 to initiate an automatic group call for individuals corresponding to all tagged objects 410, 420, 430, and 440 in the image 400, according to an exemplary embodiment of the present invention

Referring to FIG. 4A, the image 400 displayed on a display includes the tagged objects 410, 420, 430, and 440. A user moves his or her finger 450 from left to right across the all tagged objects 410, 420, 430, and 440 in the image 400. The swipe right gesture 460 may be predefined (preconfigured) to initiate a group call for individuals corresponding to all the tagged objects 410, 420, 430, and 440 in the image 400 by accessing telephone numbers of the individuals among contact details that are stored in a contact list on the computing device 100.

FIG. 4B illustrates a swipe left gesture 470 performed on an image 400 to trigger automatic text messaging for individuals corresponding to all tagged objects 410, 420, 430, and 440 in the image 400, according to an exemplary embodiment of the present invention.

Referring to FIG. 4B, a user moves his or her finger 450 from right to left across the all tagged objects 440, 430, 420, and 410 in the image 400 displayed on a display. The swipe left gesture 470 may be predefined to initiate group texting for individuals corresponding to all the tagged objects 410, 420, 430, and 440 in the image 400 by accessing telephone numbers of the individuals among contact details that are stored in a contact list on the computing device 100. For example, an SMS may be sent to the individuals corresponding to all the tagged objects 440, 430, 420, and 410.

In one embodiment, by performing a long tap on any portion of an image that is viewed by a user, emailing may be initiated for individuals corresponding to all tagged objects in the image.

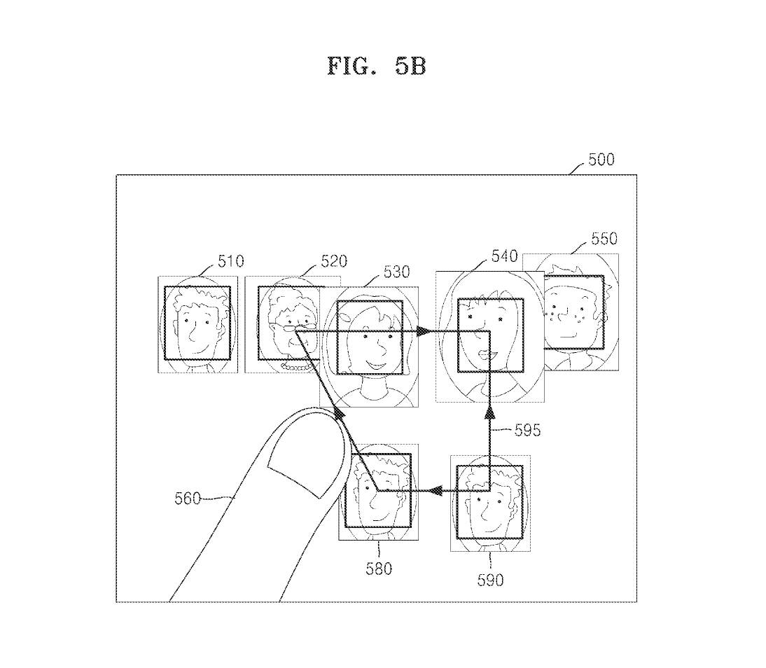

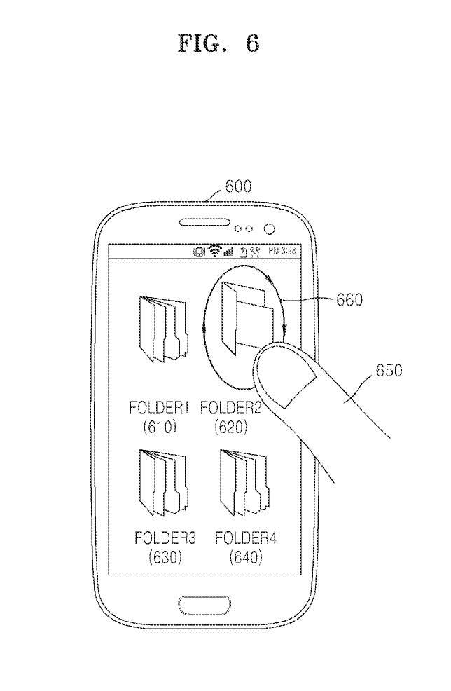

FIG. 5A illustrates a clockwise loop gesture 570 that is performed by encircling tagged objects 510, 520, and 530 in an image 500 selected by a user so as to initiate an automatic conference call for a group of individuals corresponding to the tagged objects 510, 520, and 530 within a circular loop, according to an exemplary embodiment of the present invention.

Referring to FIG. 5A, the image 500 displayed on a display includes the tagged objects 510, 520, 530, 540, and 550. A user performs the clockwise loop gesture 570 by encircling with his or her finger 560 only some of the tagged objects 510, 520, 530, 540, and 550 in the image 500 for whom the user desires to initiate a conference call. The clockwise loop gesture 570 allows the user to initiate a conference call with individuals corresponding to the selected tagged objects 510, 520, and 530 within the circular loop and not with individuals corresponding to the tagged objects 540 and 550 in the image 500 but outside the circular loop.

FIG. 5B illustrates a counter-clockwise loop gesture 595 that is performed by connecting together tagged objects 520, 530, 540, 580, and 590 in an image 500 selected by a user so as to initiate an automatic conference call for a group of individuals corresponding to objects following the loop gesture.

Referring to FIG. 5B, a user performs the counter-clockwise loop gesture 595 by connecting with his or her finger 560 only some of the tagged objects 510, 520, 530, 540, 550, 580, and 590 in the image 500 for whom the user desires to initiate a conference call. The counter-clockwise loop gesture 595 allows the user to initiate a conference call with individuals corresponding to the selected tagged objects 520, 530, 540, 580, and 590 within a connected loop and not with individuals corresponding to the tagged objects 510 and 550 in the image 500 but outside the loop.

In one embodiment, the user performs a drag gesture in a clockwise direction on at least one tagged object selected in an image so as to initiate a conference call for individuals corresponding to all tagged objects following a path along which the user drag his or her finger clockwise.

In another embodiment, a user may perform a counter-clockwise loop gesture by surrounding only some tagged objects selected by the user and for whom the user desires to send a text message (group texting). Thus, the user excludes undesired tagged objects while performing the counter-clockwise loop gesture.

In another embodiment, the user performs a drag gesture in a counter-clockwise direction on at least one tagged object selected in an image so as to initiate texting messaging for individuals corresponding to all tagged objects following the drag gesture. The drag gesture is performed by excluding individuals corresponding to tagged objects not following a path along which the user drag his or her finger counter-clockwise.

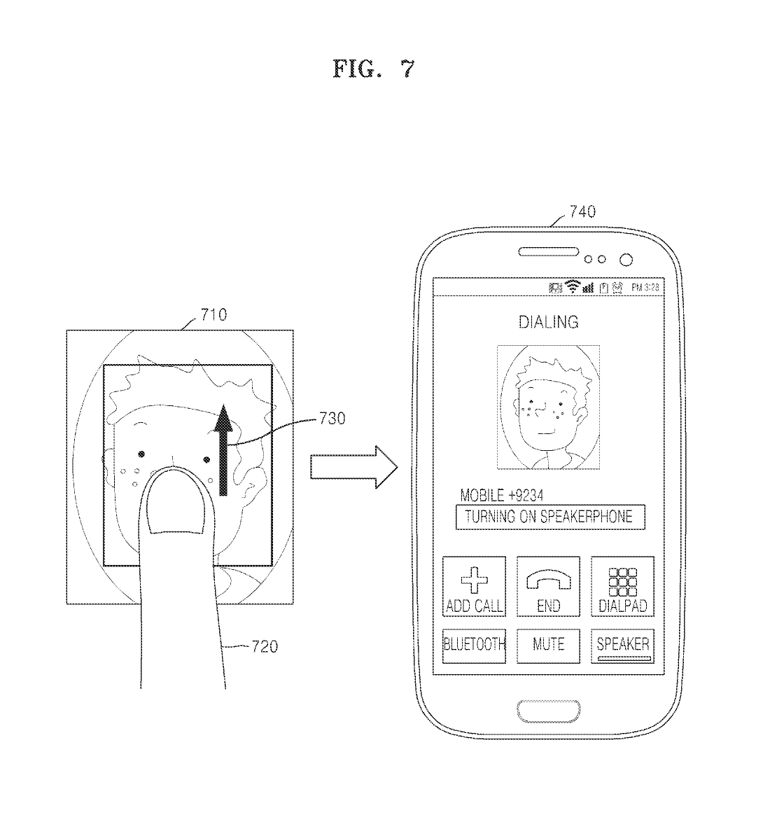

FIG. 6 illustrates a clockwise round loop gesture 660 on an image folder according to an exemplary embodiment of the present invention. The clockwise round loop gesture 660 allows a user to trigger a conference call for all individuals corresponding to tagged objects whose images are stored in the image folder.

Referring to FIG. 6, folder 1 610, folder 2 620, folder 3 630, and folder 4 640 are displayed on a display of a device 600. The user performs the clockwise round loop gesture 660 around an image of the folder 2 620 by using his or her finger 650. The clockwise round loop gesture 660 allows the user to initiate a conference call for individuals corresponding to all tagged objects whose images are stored in the folder 2 620. Thus, the user does not need to open the folder 2 620, view all images in the folder 2 620, and perform the desired gesture on all images of interest.

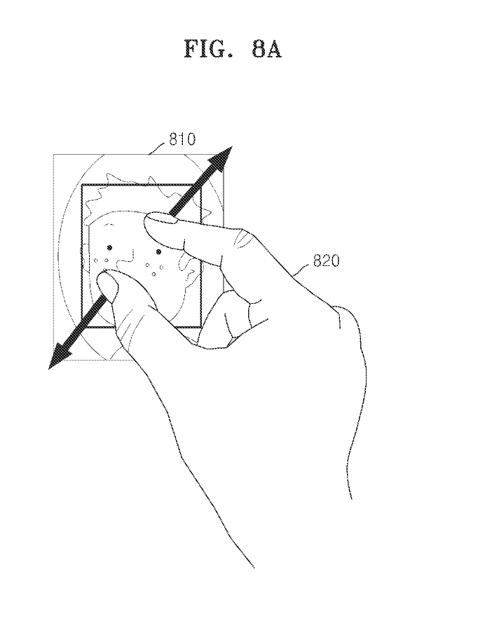

FIG. 7 illustrates a swipe up gesture 730 performed on a tagged object to trigger an automatic call for an individual corresponding to the tagged object, according to an exemplary embodiment of the present invention.

Referring to FIG. 7, by performing the swipe up gesture 730 on a tagged object 710 contained in an image by using his or her finger 720, a user initiates a call 740 for the individual corresponding to the tagged object.

In one embodiment, a swipe down gesture allows a user to initiate text messaging for an individual corresponding to a tagged object.

In another embodiment, a long tap gesture allows a user to initiate emailing for an individual corresponding to a tagged object.

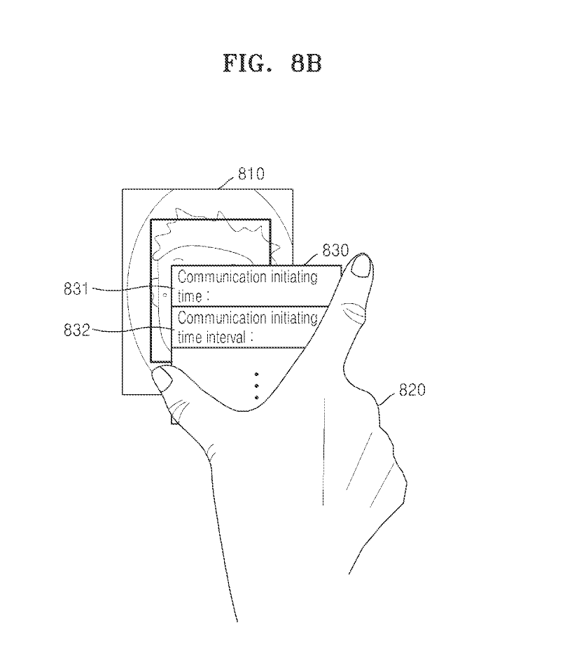

FIGS. 8A and 8B illustrate a pinch gesture or spread gesture that is performed on an individual corresponding to a tagged object 810 by using two fingers 820.

Referring to FIG. 8A, by performing a spread gesture on the tagged object 810 contained in an image with his or her thumb and index finger, a user may use an option for further details with which he or she desires to be provided. For example, by performing a spread gesture as shown in FIG. 8B, the user may be provided with an option window 830 containing fields for entering details such as time 831 when communication is initiated and time interval 832 at which the user desires to initiate desired communication.

In another embodiment, a rotation gesture with a user's fingers may be mapped for a unique way of initiation of communication.

In another embodiment, a dag and flick gesture, e.g., a drag gesture including a drag from a selected tagged object to a left bottom corner of an image allows a user to initiate (schedule) a group call at a predetermined time in future and immediately initiate an SMS so that the user may send a reminder for the scheduled group call to a selected group

A conventional group calling or group texting process includes multiple steps that need to be performed by a user. Furthermore, the step of setting a group call may be a little cumbersome. However, one or more embodiments of the present invention described above provide a touch gesture that allows a user to easily select a desired person while creating a group for initiating a group call and exclude an unwanted person. The embodiments of the present invention improve user experience by realizing characteristics of a group call directly in an image viewer. The embodiments may also provide a method of contacting a user's social circle in a prompt, easy, user-friendly way.

The description of a specific embodiment provides a complete disclosure of the entire features of the present embodiment, such that one of ordinary skill in the art may apply current knowledge to easily change and/or modify the specific embodiment without departing from comprehensive concepts thereof. Such changes and modifications within the scope of the present embodiment and its equivalents will be construed as being included in the present invention. The expressions and terms used herein is used for the purpose of describing particular embodiments only, and is not intended to limit the scope of the present invention. While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A method of initiating communication in a computing device including a touch sensitive display, the method comprising:
detecting a touch gesture that is performed on at least one tagged object included in an image displayed on the touch sensitive display; and
initiating, in response to the detection of the touch gesture, communication to at least one individual corresponding to the at least one tagged object selected or surrounded by the detected touch gesture, according to the detected touch gesture.

2. The method of claim 1, wherein the initiating of the communication according to the detected touch gesture comprises initiating communication for individuals corresponding to all tagged objects selected or surrounded by the touch gesture.

3. The method of claim 1, wherein the communication comprises at least one of making a call, sending a text message, and sending an email to the at least one individual corresponding to the at least one tagged object selected or surrounded by the touch gesture.

4. The method of claim 1, wherein the touch gesture comprises at least one of:
a swipe right gesture on the at least one tagged object included in the image;
a swipe left gesture on the at least one tagged object included in the image;
a drag gesture in clockwise direction on the at least one tagged object included in the image;
a drag gesture in counter-clockwise direction on the at least one tagged object included in the image;
a loop gesture performed by encircling at least one tagged object selected from among a plurality of tagged objects in the image;
a swipe up gesture on the at least one tagged object included in the image;
a swipe down gesture on the at least one tagged object included in the image;
a long tap gesture on the at least one tagged object included in the image; and
a loop gesture performed by surrounding a folder containing a plurality of tagged images.

5. The method of claim 1, wherein the initiating of the communication based on the detected touch gesture comprises identifying the at least one individual corresponding to the at least one tagged object that is stored in a contact list on the computing device and initiating the communication to the individual.

6. A computing device comprising:
a touch sensitive display;
a memory for storing at least one instruction; and
a processor for executing the at least one instruction,
wherein the processor detects a touch gesture that is performed on at least one tagged object included in an image displayed on the touch sensitive display, in response to the execution of the at least one instruction, and initiates communication to at least one individual corresponding to the at least one tagged object selected or surrounded by the detected touch gesture according to the detected touch gesture, in response to the detection of the touch gesture.

7. The computing device of claim 6, wherein the processor simultaneously initiates communication to individuals corresponding to all tagged objects selected or surrounded by the touch gesture, in response to the execution of the at least one instruction.

8. The computing device of claim 6, wherein the communication comprises at least one of making a call, sending a text message, and sending an email to the at least one individual corresponding to the at least one tagged object selected or surrounded by the touch gesture.

9. The computing device of claim 6, wherein the touch gesture comprises at least one of:
a swipe right gesture on the at least one tagged object included in the image;
a swipe left gesture on the at least one tagged object included in the image;
a drag gesture in clockwise direction on the at least one tagged object included in the image;
a drag gesture in counter-clockwise direction on the at least one tagged object included in the image;
a loop gesture performed by encircling at least one tagged object selected from among a plurality of tagged objects in the image;
a swipe up gesture on the at least one tagged object included in the image;
a swipe down gesture on the at least one tagged object included in the image;
a long tap gesture on the at least one tagged object included in the image; and
a loop gesture performed by surrounding a folder containing a plurality of tagged images.

10. The computing device of claim 6, wherein in response to the execution of the at least one instruction, the processor identifies the at least one individual corresponding to the at least one tagged object that is stored in a contact list on the computing device and initiates the communication to the individual.

11. A non-transitory computer-readable recording medium having recorded thereon a program for executing the method of one of claim 1 on a computer.
